(19) United States
(12) Patent Application Publication
(10) Pub. No.: US 2010/0141587 A1
(43) Pub. Date: Jun. 10, 2010

(54) ELECTRONIC DEVICE HAVING RECONFIGURABLE KEYBOARD LAYOUT AND METHOD FOR RECONFIGURING KEYBOARD LAYOUT

(75) Inventors: Yukio Takahashi, Tokyo (JP); Takayuki Maeda, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/541,313

(22) Filed: Aug. 14, 2009

(30) Foreign Application Priority Data
Dec. 10, 2008 (JP) P2008-314809

(51) Int. Cl. G06F 3/02; H04M 1/02

(52) U.S. Cl. 345/169; 455/575.4; 345/170

(57) ABSTRACT

An electronic device having a plurality of operation keys, a position sensor, a keyboard layout controller and a keyboard illumination controller is provided. The operation keys are configured to form a reconfigurable keyboard layout. The keyboard layout controller is configured to reconfigure the keyboard layout in accordance with the position of the electronic device sensed by the position sensor. The keyboard illumination controller is configured to illuminate one of the operation keys being usable in the keyboard layout after the reconfiguration.

### CROSS-REFERENCE TO RELATED APPLICATION

This application is based upon and claims the benefit of priority from the prior Japanese Patent Application No. 2008-314809 filed on Dec. 10, 2008;

the entire contents of which are incorporated herein by reference.

### BACKGROUND OF THE INVENTION

(i) Field of the Invention

The present invention relates to an electronic device, and in particular to an electronic device having a plurality of operation keys forming a keyboard of a reconfigurable layout. The electronic device is configured to change usable operation keys depending on its position, and to illuminate the usable operation keys so as to let a user know that the illuminated operation keys are usable.

(ii) Description of the Related Art

An electronic device that allows reconfiguration of a keyboard layout in accordance with a user's preference has been recently developed. Although the keyboard layout can be easily reconfigured, however, the reconfigured keys can be hardly indicated. Therefore, it is unclear for the user which function is allocated to which key, resulting in a problem that user operability is degraded.

Therefore, a mobile phone configured to indicate a keyboard layout immediately after the keyboard layout is reconfigured at will, and to display character data according to input conditions of each of numerals, syllabic Japanese characters, alphabetic characters and so on has been proposed as disclosed in Japanese Patent Publication of Unexamined Applications (Kokai) No. 2003-152853. The mobile phone of JP 2003-152853 has a function of keyboard reconfiguration on a touch panel, and is so configured that one of a plurality of preset keyboard layouts can be selected at will so that the whole keyboard is interchanged with the selected keyboard layout at once. Instead, the mobile phone of JP 2003-152853 may be so configured that a target key and a candidate key to be interchanged are selected, and then interchanged.

Particularly, an electronic device such as a mobile phone having a sideways slide-out qwerty keyboard can be used in a sideways arrangement and in a qwerty keyboard layout of the operation keys. Such an electronic device can be put lengthwise and used with one hand in a numeric keypad layout of the operation keys. An electronic device having a re-configurable keyboard layout in accordance with a method for use, as described above, should preferably be configured to let a user easily know the keyboard layout that is currently used.

### SUMMARY OF THE INVENTION

Accordingly, an advantage of the present invention is that an electronic device configured to reconfigure a keyboard layout in accordance with a method for use can let a user easily know the keyboard layout that is currently used.

To achieve the above advantage, one aspect of the present invention is to provide an electronic device having a plurality of operation keys, a position sensor, a keyboard layout controller and a keyboard illumination controller. The operation keys are configured to form a reconfigurable keyboard layout. The keyboard layout controller is configured to reconfigure the keyboard layout in accordance with the position of the electronic device sensed by the position sensor. The keyboard illumination controller is configured to illuminate one of the operation keys being usable in the keyboard layout after the reconfiguration.

### BRIEF DESCRIPTION OF THE DRAWINGS

An embodiment of the present invention will be de-scribed in detail on the basis of the following drawings, wherein:

FIG. 1A is a perspective view of an electronic device (mobile phone) of the embodiment of the present invention being open. FIG. 1B is a perspective view of the electronic device (mobile phone) of the embodiment being closed;

FIG. 2 is a functional block diagram of the electronic device (mobile phone) of the embodiment;

FIG. 3 illustrates transitions of open/closed states of the mobile phone of the embodiment, starting from a closed state to a first open state showing operation keys to be used if the mobile phone is open and held lengthwise by a right hand, to a second open state showing operation keys to be used if the mobile phone is open and held lengthwise by a left hand, and to a third open state showing operation keys to be used if the mobile phone is open and held sideways;

FIG. 4 is a flowchart of a key illumination control process of the electronic device (mobile phone) of the embodiment;

FIG. 5 shows examples of illumination of the operation keys of the mobile phone of the embodiment, including the operation keys illuminated if the mobile phone is open and held lengthwise by a right hand, the operation keys illuminated if the mobile phone is open and held lengthwise by a left hand, and the operation keys illuminated if the mobile phone is open and held sideways;

FIG. 6A is a diagram showing an example of an ar-rangement of light guiding modules for illuminating the operation keys of the mobile phone of the embodiment. FIG. 6B is a table showing conditions of illuminating each of the light guiding modules;

FIG. 7A is a diagram showing an example of an ar-rangement of light guiding modules for illuminating the operation keys of the mobile phone of the embodiment. FIG. 7B is a table showing conditions of illuminating each of the light guiding modules;

FIGS. 8A and 8B are schematic diagrams showing a configuration for illuminating the operation keys of the mobile phone of the embodiment; and

FIG. 9A shows an example of illumination of the operation keys while the mobile phone of the embodiment is being open and held lengthwise. FIG. 9B shows an example of illumination of the operation keys while the mobile phone of the embodiment is being open and held sideways.

### DETAILED DESCRIPTION OF THE INVENTION

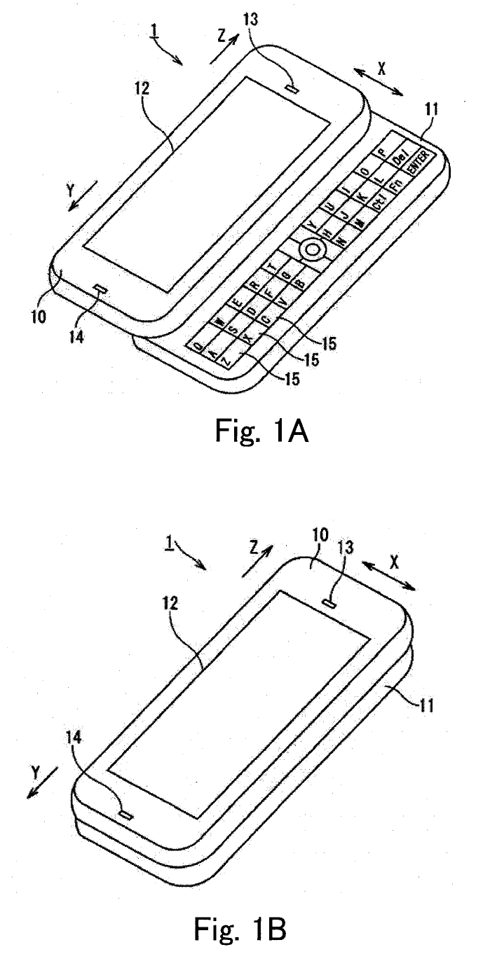

An embodiment of the present invention will be described with reference to FIGS. 1-9B A mobile phone 1, which includes two housing sections connected to each other in such a way as to slide against each other and configured to be open and closed to each other, will exemplify an electronic device of the embodiment.

FIG. 1A is a perspective view showing a mobile phone 1 while the housings are being open to each other. FIG. 1B is a perspective view showing the mobile phone 1 while the housings are being closed to each other. As shown in FIGS. 1A and 1B, the mobile phone 1 is constituted by a rectangular plate-like formed upper housing 10 and a lower housing 11 of substantially the same shape as the upper housing 10. While being closed to each other, the upper and lower housings 10 and 11 are stacked so that the upper housing 10 covers a face of the lower housing 11 and vice versa. The upper housing 10 and the lower housing 11 are connected in such a way as to slide against each other in a particular direction (X-direction shown in FIG. 1) by a certain length. The upper housing 10 is configured to slide against the lower housing 11 so that the mobile phone 1 can change its state from closed to open, and vice versa.

An outer face of the upper housing 10 (on a side not facing the lower housing 11) is provided with a display 12 of a rectangular shape for displaying a screen formed by text, images, etc., a speaker 13 for producing voice and sound, and a microphone 14 for collecting voice and sound. The display 12, the speaker 13 and the microphone 14 are provided in such a way as to be exposed to the outside regardless of whether the mobile phone 1 is closed or open. Accordingly, the mobile phone 1 can allow a user to view a screen on the display 12, or to perform voice communication by using the mobile phone 1, regardless of whether the mobile phone 1 is closed or open.

An inner face of the lower housing 11 (on a side facing the upper housing 10) is provided with a plurality of operation keys 15 which a user can press so as to provide the mobile phone 1 with directions. If the mobile phone 1 is closed, these operation keys 15 are covered by the upper housing 10 and thus are not exposed to the outside. If the upper housing 10 slides against the lower housing 11 and thus the mobile phone 1 opens, the operation keys 15 are exposed to the outside. Accordingly, if the mobile phone 1 is open, a user can provide the mobile phone 1 with directions through the operation keys 15. If the mobile phone 1 is closed, the user cannot provide the mobile phone 1 with directions through the operation keys 15.

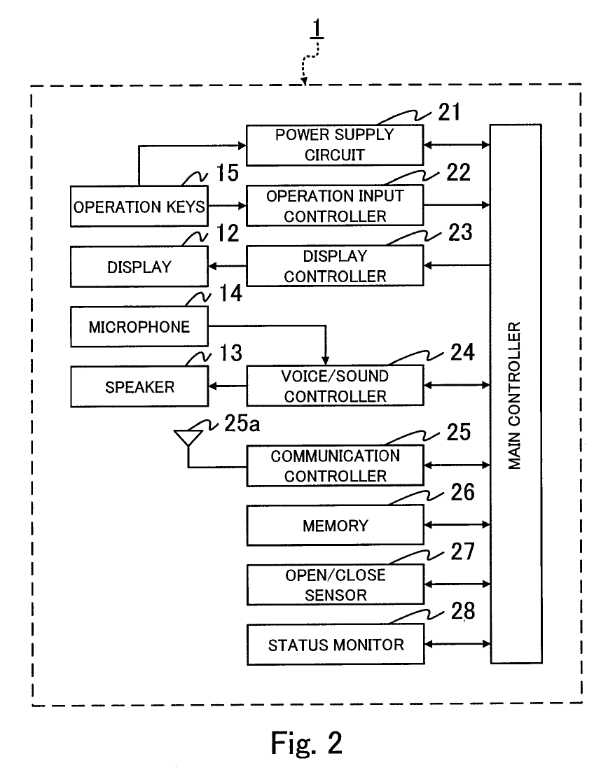

FIG. 2 is a functional block diagram of the mobile phone 1. As shown in FIG. 2, the mobile phone 1 includes a main controller 20, a power supply circuit 21, an operation input controller 22, a display controller 23, a voice/sound controller 24, a communication controller 25, a memory 26, an open/closed sensor 27 and a position sensor 28, which are connected to one another through a bus so as to communicate with one another.

The main controller 20 has a CPU (central processing unit), comprehensively controls the mobile phone 1 and performs various arithmetic and control processes and so on. The power supply circuit 21 has a power supply source such as a battery or the like, and switches the power supply on and off depending on a user's input operation through the operation keys 15. If the power supply is turned on, the power supply circuit 21 supplies each of portions of the mobile phone 1 with power from the power supply source to each of the portions so as to activate the mobile phone.

The operation input controller 22 has an input interface for the operation keys 15. Upon sensing a push on one of the operation keys 15, the operation input controller 22 generates a signal representing the pushed one of the operation keys 15 and transmits the signal to the main controller 20. Upon receiving the signal, the main controller 20 performs a process according to the signal. Upon receiving a signal from the display controller 23, the open/closed sensor 27 or the position sensor 28, the operation input controller 22 controls a process for illuminating the operation keys 15.

The display controller 23 has a display interface for the display 12. The display controller 23 is controlled by the main controller 20 so as to display a screen formed by text, an image, etc. on the display 12, and to switch power supplied to the display 12 on and off. Moreover, the display controller 23 controls the direction of a screen displayed on the display 12 in accordance with the position of the mobile phone 1. If the mobile phone 1 is positioned lengthwise (the Y- or Z-direction shown in FIG. 1A is vertical), e.g., the display controller 23 displays a screen on the display 12 with the shorter side at the top. If the mobile phone 1 is positioned sideways (the Y- or Z-direction shown in FIG. 1A is horizontal), the display controller 23 displays a screen on the display 12 with the longer side at the top.

While displaying a screen on the display 12, the display controller 23 is directed by the main controller 20 or the operation input controller 22 so as to generate a signal representing the direction of the screen, and transmits the signal to the main controller 20 or the operation input controller 22. If the longer side of the display 12 (the Y-direction shown in FIG. 1) is in the top-to-bottom direction of the screen, e.g., the display controller 23 determines that the screen is displayed with the shorter side at the top. If the longer side of the display 12 is in the left-to-right direction of the screen, the display controller 23 determines that the screen is displayed with the longer side at the top.

The voice/sound controller 24 is controlled by the main controller 20 so as to generate an analog voice signal from voice collected by the microphone 14, and converts this analog voice signal to a digital voice signal. Upon obtaining a digital voice signal, the voice/sound controller 24 is controlled by the main controller 20 so as to convert the digital voice signal to an analog voice signal, and produces voice from the speaker 13.

The communication controller 25 is controlled by the main controller 20 so as to de-spread a spread spectrum signal received from a base station (not shown) through an antenna 25a so as to restore data carried by the received signal. The communication controller 25 can be controlled by the main controller 20 so as to provide the data to the voice/sound controller 24 so that voice based on the data is produced through the speaker 13, to the display controller 23 so that the data is displayed on the display 12, or to the memory 26 so that the data is stored in the memory 26. Moreover, upon obtaining voice data collected by the microphone 14, data entered through the operation keys 15 or data stored in the memory 26, the communication controller 25 performs a spectrum spreading process on the data, and transmits the processed data to the base station through the antenna 25a.

The memory 26 includes a ROM (read only memory) or a hard disk for storing a program of a process performed by the main controller 20 and the operation input controller 22, data required for the process and so on. The memory 26 includes a non-volatile memory, a database, a RAM (random access memory) for temporarily storing data which the main controller 20 and the operation input controller 22 uses while performing the process. Moreover, it is assumed, e.g., that a program for controlling operation key illumination performed by the operation input controller 22 is stored in the ROM.

The open/closed sensor 27 has a Hall IC and a magnet which are, e.g., provided on the upper housing 10 and on the lower housing 11, respectively. The Hall IC and the magnet are provided so that the Hall IC senses magnetism of the magnet while the mobile phone 1 is being closed. Upon the Hall IC sensing the magnetism of the magnet, the open/closed sensor 27 determines that the mobile phone 1 is being closed. Upon the Hall IC detecting no magnetism of the magnet, the open/closed sensor 27 determines that the mobile phone 1 is being open. The Hall IC is a component constituted by a Hall element, i.e., a magnetic sensor and an IC for converting an output signal of the Hall element to a digital signal contained in one package, and has four terminals which are a power supply terminal, a ground terminal, an output terminal for south pole detection and an output terminal for north pole detection.

Upon detecting a transition from a closed state to an open state of the mobile phone 1, the open/closed sensor 27 generates an open state detection signal and transmits the signal to the main controller 20 and the operation input controller 22. Upon detecting a transition from an open state to a closed state of the mobile phone, the open/closed sensor 27 generates a closed state detection signal and transmits the signal to the main controller 20 and the operation input controller 22.

The position sensor 28 has an accelerometer sensor, and is controlled by the main controller 20 and the operation input controller 22 so as to sense a position of being held or placed of the mobile phone 1 by using a value sensed by the accelerometer sensor. If the longer side of the housing (corresponding to Y- or Z-direction shown in FIG. 1) is vertically directed, e.g., the position sensor 28 senses that the mobile phone 1 is held lengthwise. If the longer side of the housing is horizontally directed, the position sensor 28 senses that the mobile phone 1 is held sideways. If the longer side of the housing is vertically directed, the open/closed sensor 27 further determines whether gravity is in the Y-direction or in the Z-direction. The position sensor 28 is controlled by the main controller 20 and the operation input controller 22 so as to generate data indicating the position of the mobile phone 1 and transmits the data to the main controller 20 and the operation input controller 22.

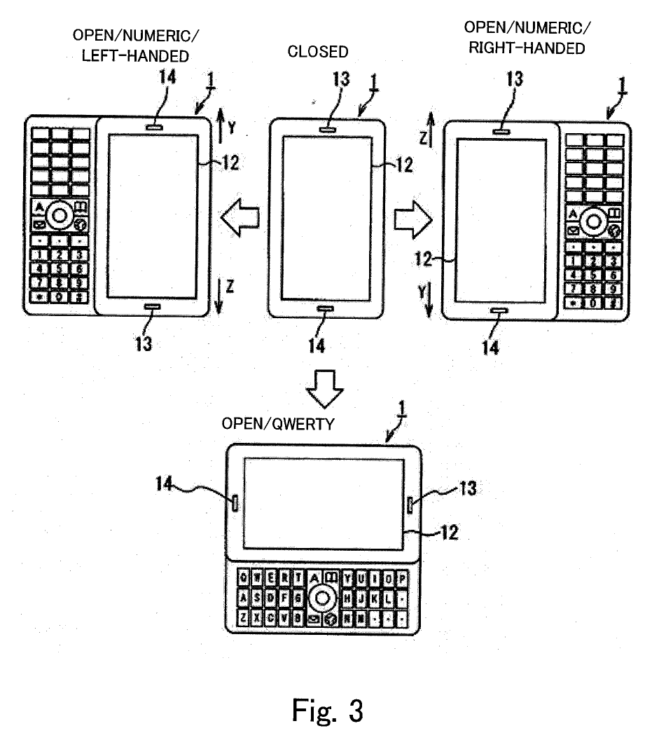

FIG. 3 illustrates transitions of the open/closed state of the mobile phone 1. The mobile phone 1 is closed in the upper middle of FIG. 3 (indicated as “CLOSED”). The mobile phone 1 is open to be held lengthwise with a right hand in the upper right of FIG. 3, where the operation keys 15 show a right-handed numeric keypad layout (indicated as “OPEN/NUMERIC/RIGHT-HANDED”). The mobile phone 1 is open to be held lengthwise with a left hand in the upper left of FIG. 3, where the operation keys 15 show a left-handed numeric keypad layout (indicated as “OPEN/NUMERIC/LEFT-HANDED”). The mobile phone 1 is open to be held sideways in the lower half of FIG. 3, where the operation keys 15 show a qwerty keyboard layout (“OPEN/QWERTY”).

That is, if the mobile phone 1 is closed as shown in the upper middle of FIG. 3, the operation keys 15 provided to the lower housing 11 are covered by the upper housing 10, and thus cannot be used. If the mobile phone 1 is open to be held lengthwise with a right hand as shown in the upper right of FIG. 3 (in a case where the gravity is in the Y-direction shown there), a portion of the operation keys 15 indicated with numerals and symbols are usable in the right-handed numeric keypad layout. If the mobile phone 1 is held by a user with his or her right hand (in a case where the gravity is in the Y-direction shown there), the operation keys 15 and the display 12 are arranged on the right side and the left side, respectively, as viewed from the front.

If the mobile phone 1 is open to be held lengthwise with a left hand as shown in the upper left of FIG. 3 (in a case where the gravity is in the Z-direction shown there), a portion of the operation keys 15 indicated by numerals and symbols are usable in the left-handed numeric keypad layout. If the mobile phone 1 is held by a user with his or her left hand (in a case where the gravity is in the Z-direction shown there), the operation keys 15 and the display 12 are arranged on the left side and the right side, respectively, as viewed from the front. Moreover, if the mobile phone 1 is open to be held sideways by a user as shown in the lower half of FIG. 3, the operation keys 15 are usable in the qwerty keyboard layout.

As described above, the mobile phone 1 is configured to judge whether the gravity is in the Y-direction or in the Z-direction, or the mobile phone 1 is held sideways depending upon its open/closed state and its position of being held or placed by a user. The mobile phone 1 is configured to reconfigure the keyboard layout of the operation keys 15 between the numeric keypad layout and the qwerty keyboard layout on the basis of the above judgment. Moreover, the mobile phone 1 is configured to illuminate a portion of the operation keys 15 being usable in each of the above numeric keypad and qwerty keyboard layouts so as to let a user know which ones of the operation keys 15 are currently usable.

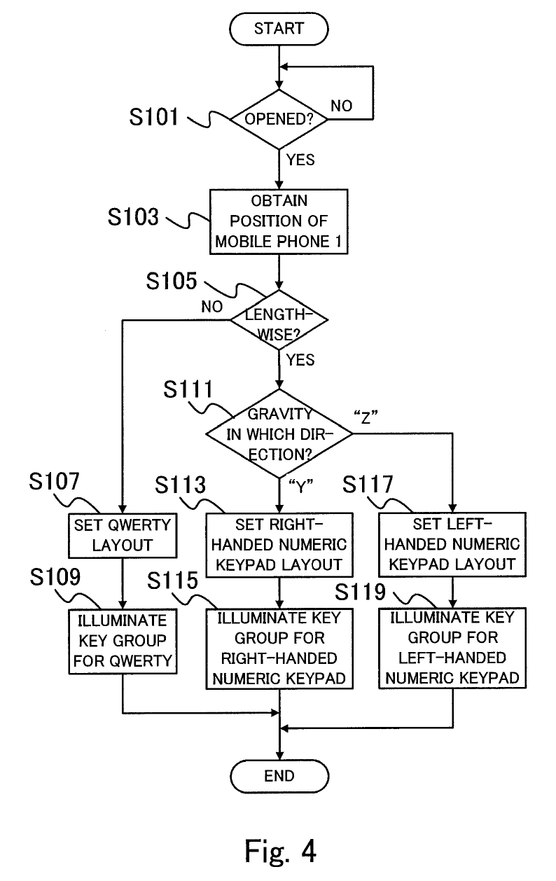

Such an operation key illumination control process of the mobile phone 1 will be described with reference to a flowchart shown in FIG. 4, in an assumption that the mobile phone 1 opens after being closed. Hereafter, a term such as “step S101” is shortened as “S101” by omitting the term “step”.

The operation input controller 22 first determines whether the mobile phone 1 is opened or not (S101). At this moment, upon receiving an open detection signal from the open/closed sensor 27, the operation input controller 22 determines that the mobile phone 1 is opened. If the mobile phone 1 is not opened (“NO” of 5101), the operation input controller 22 is kept on standby.

If the mobile phone 1 is opened (“Yes” of 5101), the operation input controller 22 obtains a signal indicating a position of the mobile phone 1 from the position sensor 28 (S103). The operation input controller 22 determines whether the mobile phone 1 is held lengthwise by a user on the basis of the signal obtained at 5103 (S105).

If the mobile phone 1 is not held lengthwise but held sideways (“NO” of S105), the operation input controller 22 sets the qwerty keyboard layout shown in the lower half of FIG. 3 on the operation keys 15 (S107). Furthermore, the operation input controller 22 illuminates a portion of the operation keys 15 used in the qwerty keyboard layout (S109).

If the mobile phone 1 is held lengthwise (“YES” of S105), the operation input controller 22 determines which direction the gravity is in (e.g., whether the gravity is in the Y-direction or in the Z-direction, both shown in FIG. 1) on the basis of the signal obtained at S103 (S111).

Upon determining that the gravity is in the Y-direction (“Y” of S111), the operation input controller 22 sets the right-handed numeric keypad layout shown in the upper right of FIG. 3 on the operation keys 15 (S113). Moreover, the operation input controller 22 illuminates the usable ones of the operation keys 15 in the right-handed numeric keypad layout (S115).

Meanwhile, upon determining that the gravity is in the Z-direction (“Z” of S111), the operation input controller 22 sets the left-handed numeric keypad layout on the operation keys 15 (S117). Moreover, the operation input controller 22 illuminates the usable ones of the operation keys 15 in the left-handed numeric keypad layout (S119).

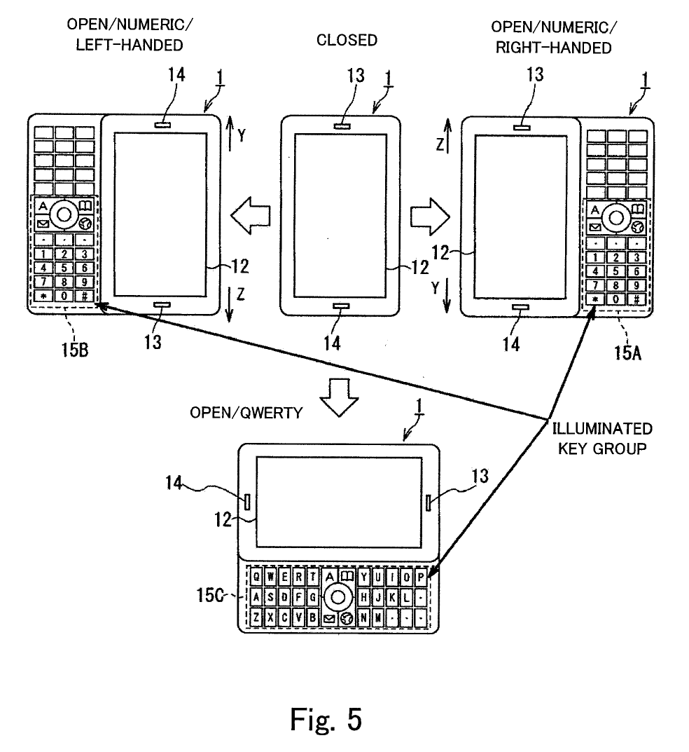

FIG. 5 shows examples of illumination of the operation keys 15. The mobile phone 1 is closed in the upper middle of FIG. 5 (“CLOSED”). If the mobile phone 1 is open and held lengthwise and the gravity is in the Y-direction, the usable ones of the operation keys 15 in the right-handed numeric keypad layout are illuminated as shown in the upper right of FIG. 5. If the mobile phone 1 is open and held lengthwise and the gravity is in the Z-direction, the usable ones of the operation keys 15 in the left-handed numeric keypad layout are illuminated as shown in the upper left of FIG. 5. If the mobile phone 1 is open and held sideways, the operation keys 15 are illuminated as shown in the lower half of FIG. 5.

If the mobile phone 1 is closed, as the operation keys 15 are not exposed to the outside as shown in the upper middle of FIG. 5, none of the operation keys 15 is illuminated. If the mobile phone 1 is open and is held lengthwise and the gravity is in the Y-direction (held with a right hand), the usable ones of the operation keys 15 in the right-handed numeric keypad layout (collectively called a key group 15A) are illuminated (refer to S115) as shown in the upper right of FIG. 5.

If the mobile phone 1 is open and is held lengthwise and the gravity is in the Z-direction (held with a left hand), the usable ones of the operation keys 15 in the left-handed numeric keypad layout (collectively called a key group 15B) are illuminated (refer to S119) as shown in the upper left of FIG. 5. If the mobile phone 1 is open and is held sideways, as shown in the lower half of FIG. 5, the usable ones of the operation keys 15 in the qwerty keyboard layout (collectively called a key group 15C) are illuminated (refer to S109).

The process from S103 to S119 is performed upon the mobile phone 1 being open after being closed at S101, as described above. The process from S103 to S119 may be performed upon the mobile phone 1 changing its position at S101, instead. In such a case, the operation input controller 22 forwards the process to “YES” of S101 upon receiving a signal from the position sensor 28.

The operation input controller 22 may receive a signal indicating a screen direction on the display 12 from the display controller 23 instead of receiving the signal indicating a position of the mobile phone 1 from the position sensor 28. In a case where, e.g., a user lies down and operates the mobile phone 1, it is conceivable that the mobile phone 1 is held sideways and the screen is displayed on the display 12 with the shorter side at the top. In such a case, the mobile phone 1 can set the keyboard layout of the operation keys 15 in accordance with the screen direction on the display 12 so as to enhance user operability.

As described above, upon being open after being closed, or upon changing its state (i.e., how a user holds the mobile phone 1), the mobile phone 1 reconfigures the keyboard layout of the operation keys 15 into a proper one according to the state after the change, and illuminates usable ones of the operation keys 15 in the keyboard layout after the reconfiguration. The mobile phone 1 can thereby enable a user who is operating the mobile phone 1 to visually recognize the usable ones of the operation keys 15 right away.

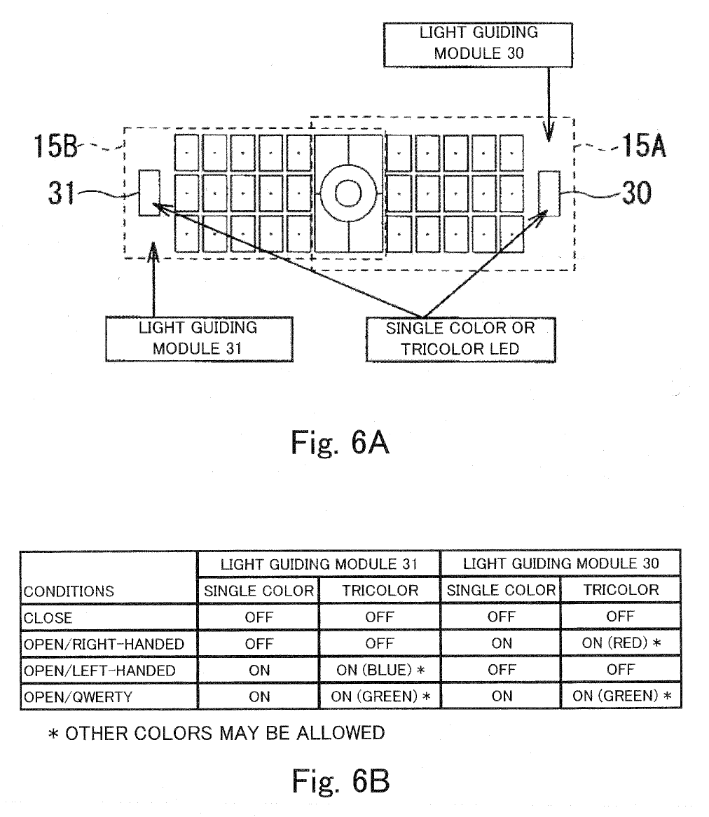

FIG. 6A is a diagram showing an example of an arrangement of light guiding modules 30 and 31 for illuminating the operation keys 15 of the mobile phone 1. FIG. 6B is a table showing conditions of illuminating each of the light guiding modules 30 and 31. As shown in FIG. 6A, the mobile phone 1 is provided with the light guiding module 30 for illuminating the key group 15A that is usable in the right-handed numeric keypad layout (while the gravity is being in the Y-direction shown in FIG. 1), and the light guiding module 31 for illuminating the key group 15B that is usable in the left-handed numeric keypad layout (while the gravity is being in the Z-direction shown in FIG. 1). The key group 15C that is usable in the qwerty keyboard layout (while the Y- and Z-directions shown in FIG. 1 are being horizontal) is constituted by all the operation keys 15 of the mobile phone 1.

Assume that the light guiding modules 30 and 31 are of a single color type. As shown in FIG. 6B, if the mobile phone 1 is closed, e.g., both the light guiding modules 30 and 31 are turned off. If the mobile phone 1 is open and is held lengthwise with a user's right hand, the light guiding modules 30 and 31 are turned on and off, respectively. If the mobile phone 1 is open and is held lengthwise with a user's left hand, the light guiding modules 30 and 31 are turned off and on, respectively. If the mobile phone 1 is open and is held sideways, both the light guiding modules 30 and 31 are turned on.

Assume that the light guiding modules 30 and 31 are of a tricolor type. As shown in FIG. 6B, if the mobile phone 1 is closed, e.g., both the light guiding modules 30 and 31 are turned off. If the mobile phone 1 is open and is held lengthwise with a user's right hand, the light guiding module 30 is turned on in red, and the light guiding module 31 is turned off. If the mobile phone 1 is open and is held lengthwise with a user's left hand, the light guiding module 30 is turned off and the light guiding module 31 is turned on in blue. If the mobile phone 1 is open and is held sideways, both the light guiding modules 30 and 31 are turned on in green.

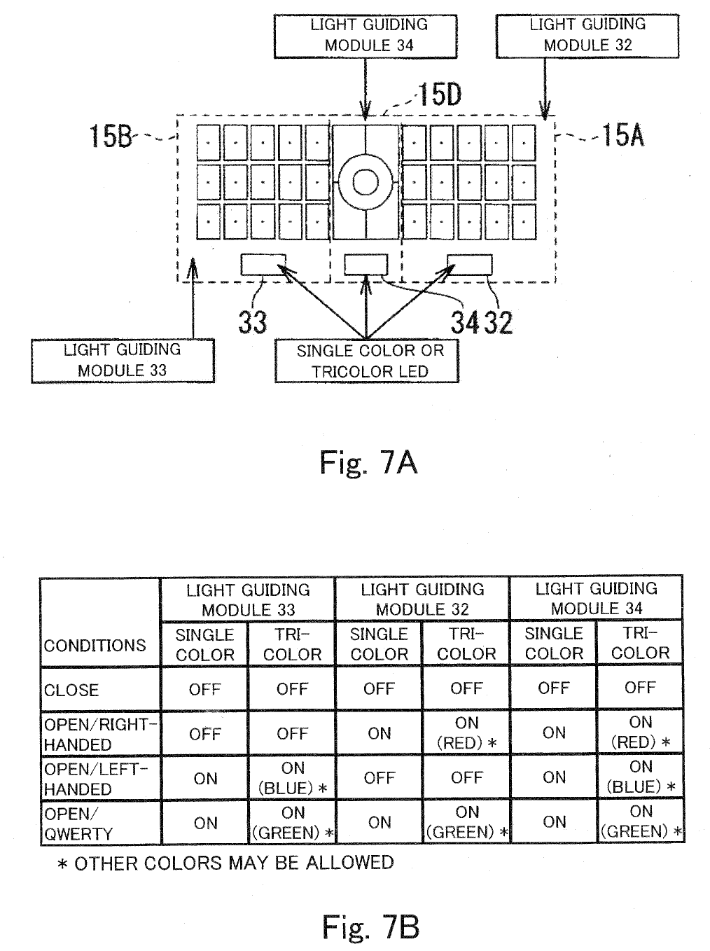

FIG. 7A is a diagram showing an example of an arrangement of light guiding modules 32, 33 and 34 for illuminating the operation keys 15 of the mobile phone 1. FIG. 7B is a table showing conditions of illuminating each of the light guiding modules 32, 33 and 34. As shown in FIG. 7A, the mobile phone 1 is provided with the light guiding module 32 for illuminating the key group 15A that is usable in the right-handed numeric keypad layout, the light guiding module 33 for illuminating the key group 15B that is usable in the left-handed numeric keypad layout, and the light guiding module 34 for illuminating the key group 15D that is usable in both the right-handed numeric keypad layout and the left-handed numeric keypad layout. The key group 15C that is usable in the qwerty keyboard layout is constituted by all the operation keys 15 of the mobile phone 1.

Assume that the light guiding modules 32-34 are of a single color type. As shown in FIG. 7B, if the mobile phone 1 is closed, e.g., all the light guiding modules 32-34 are turned off. If the mobile phone 1 is open and is held lengthwise with a user's right hand, the light guiding modules 32 and 34 are turned on, and the light guiding module 33 is turned off. If the mobile phone 1 is open and is held lengthwise with a user's left hand, the light guiding modules 33 and 34 are turned on, and the light guiding module 32 is turned off. If the mobile phone 1 is open and is held sideways, all the light guiding modules 32-34 are turned on.

Assume that the light guiding modules 32-34 are of a tricolor type. As shown in FIG. 7B, if the mobile phone 1 is closed, e.g., all the light guiding modules 32-34 are turned off. If the mobile phone 1 is open and is held lengthwise with a user's right hand, the light guiding modules 32 and 34 are turned on in red, and the light guiding module 33 is turned off.

If the mobile phone 1 is open and is held lengthwise with a user's left hand, the light guiding modules 33 and 34 are turned on in blue, and the light guiding module 32 is turned off. If the mobile phone 1 is open and is held sideways, all the light guiding modules 32-34 are turned on in green.

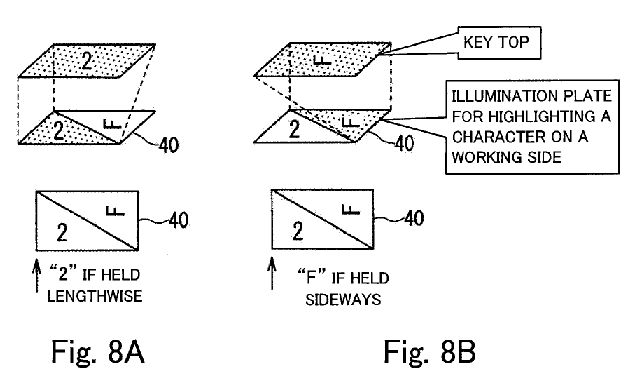

The operation keys 15 of the mobile phone 1 may be so configured that a character according to the currently set keyboard layout is indicated on a key top of each of the operation keys 15. FIGS. 8A and 8B are schematic diagrams showing a configuration for illuminating the operation keys 15 of the mobile phone 1. Each of the operation keys 15 is provided with an illumination plate 40 below the key top.

As shown in FIGS. 8A and 8B, one of the operation keys 15 that is usable in more than one of the right-handed numeric keypad layout, the left-handed numeric keypad layout and the qwerty keyboard layout is engraved with characters corresponding to the above respective layouts. If one of the layouts is set on the operation keys 15, only the character corresponding to the current layout is illuminated and projected onto the key top of each of the operation keys 15. As to one of the operation keys 15 to be used for “2” and “F” in the right-handed numeric keypad layout and in the qwerty keyboard layout, respectively, e.g., the illumination plate 40 is engraved with both “2” and “F”. If the right-handed keypad layout is set on the operation keys 15, only the numeral “2” is projected on the key top. If the qwerty keyboard layout is set on the operation keys 15, only the letter “F” is projected on the key top.

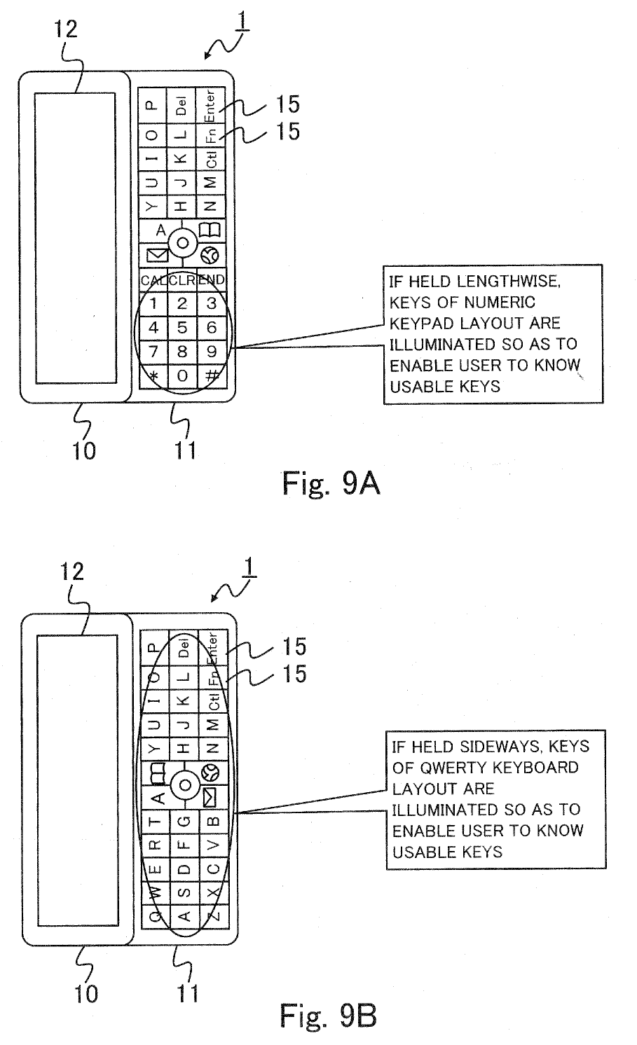

FIG. 9A shows an example of illumination of the operation keys 15 while the mobile phone 1 is being open and held lengthwise. FIG. 9B shows an example of illumination of the operation keys 15 while the mobile phone 1 is being open and held sideways.

If the mobile phone 1 is held lengthwise by a user, as shown in FIG. 9A, characters of the numeric keypad layout are projected on the respective key tops of the operation keys 15. If the mobile phone 1 is held sideways by a user, as shown in FIG. 9B, characters of the qwerty keyboard layout are projected on the respective key tops of the operation keys 15. The mobile phone 1 can thereby enable a user who is operating the mobile phone 1 to visually recognize the layout set on the operation keys 15 right away.

According to the embodiment of the present invention described above, the mobile phone 1 can set a keyboard layout of the operation keys 15 that can be reconfigured depending on a method for use, and can illuminate the keys being usable in accordance with the keyboard layout, so that a user can easily recognize the layout currently used.

Although the mobile phone 1 has been explained as an example, the electronic device of the present invention is not limited to the mobile phone 1. The present invention can be applied to any kind of electronic devices which can change the direction of a screen on a display and has a plurality of operation keys, such as a PHS (personal handy phone system), a PDA (personal digital assistant) and so on.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electronic device, comprising:
a plurality of operation keys configured to form a reconfigurable keyboard layout;
a position sensor configured to sense a position of the electronic device;
a keyboard layout controller configured to reconfigure the keyboard layout in accordance with the position of the electronic device sensed by the position sensor; and
a keyboard illumination controller configured to illuminate one of the operation keys being usable in the keyboard layout after the reconfiguration.

2. The electronic device according to claim 1, wherein
the position sensor is configured to sense a position of the electronic device upon sensing a direction of gravity.

3. The electronic device according to claim 1, further having a display unit, wherein
the position sensor is configured to sense a position of the electronic device upon being aware of a direction of a screen displayed on the display unit.

4. The electronic device according to claim 1, wherein,
the keyboard layout controller is configured to reconfigure the keyboard layout into a numeric keypad layout upon the position sensor sensing that the electronic device is positioned lengthwise.

5. The electronic device according to claim 1, wherein,
the position sensor is configured to sense a position of the electronic device upon sensing a direction of gravity, and
the keyboard layout controller is configured to reconfigure the keyboard layout into a right-handed numeric keypad layout upon the position sensor sensing that the electronic device is positioned lengthwise and that the gravity is in a first direction along a longest side of the electronic device, the keyboard layout controller being configured to reconfigure the keyboard layout into a left-handed numeric keypad layout upon the position sensor sensing that the electronic device is positioned lengthwise and that the gravity is in an opposite direction of the first direction.

6. The electronic device according to claim 1, wherein,
the keyboard layout controller is configured to reconfigure the keyboard layout into a qwerty keyboard layout upon the position sensor sensing that the electronic device is positioned sideways.

7. The electronic device according to claim 1 further comprising two housing sections connected to each other in such a way as to slide against each other, the housing sections being configured to be open and closed to each other, wherein
the position sensor is configured to sense a position of the electronic device upon the housing sections being open to each other.

8. The electronic device according to claim 1, wherein the keyboard illumination controller is configured to illuminate one of the operation keys being usable in the keyboard layout after the reconfiguration and indicating more than one characters in such a way as to illuminate one of the characters according to the keyboard layout after the reconfiguration.

9. The electronic device according to claim 1, wherein the keyboard illumination controller is configured to illuminate the operation key being usable in the keyboard layout after the reconfiguration in color distinguishing the keyboard layout.

10. A method for reconfiguring a keyboard layout of an electronic device having a plurality of operation keys, comprising:
sensing a position of the electronic device;
reconfiguring the keyboard layout in accordance with the sensed position of the electronic device; and
illuminating one of the operation keys being usable in the keyboard layout after the reconfiguration.

11. The method for reconfiguring the keyboard layout of the electronic device according to claim 10, wherein the position of the electronic device is sensed upon a direction of gravity being sensed.

12. The method for reconfiguring the keyboard layout of the electronic device according to claim 10, wherein the electronic device has a display unit, and the position of the electronic device is sensed depending upon a direction of a screen displayed on the display unit.

13. The method for reconfiguring the keyboard layout of the electronic device according to claim 10, wherein the keyboard layout is reconfigured into a numeric keypad layout upon the electronic device being positioned lengthwise.

14. The method for reconfiguring the keyboard layout of the electronic device according to claim 10, wherein
the position of the electronic device is sensed upon a direction of gravity being sensed,
the keyboard layout is reconfigured into a right-handed numeric keypad layout upon the electronic device being positioned lengthwise and the sensed direction of the gravity is in a first direction along a longest side of the electronic device, and
the keyboard layout is reconfigured into a left-handed numeric keypad layout upon the electronic device being positioned lengthwise and the sensed direction of the gravity is in an opposite direction of the first direction.

15. The method for reconfiguring the keyboard layout of the electronic device according to claim 10, wherein the keyboard layout is reconfigured into a qwerty keyboard layout upon the electronic device being positioned sideways.

16. The method for reconfiguring the keyboard layout of the electronic device according to claim 10, wherein
the electronic device has two housing sections connected to each other in such a way as to slide against each other, the housing sections being configured to be open and closed to each other, and
the position of the electronic device is sensed upon the housing sections being open to each other.

17. The method for reconfiguring the keyboard layout of the electronic device according to claim 10, wherein
one of the operation keys being usable in the keyboard layout after the reconfiguration indicates more than one characters, and
the operation key is illuminated in such a way that one of the characters according to the keyboard layout after the reconfiguration is illuminated.

18. The method for reconfiguring the keyboard layout of the electronic device according to claim 10, wherein the operation key being usable in the keyboard layout after the reconfiguration is illuminated in color distinguishing the keyboard layout.
